(19) United States
(12) Patent Application Publication
(10) Pub. No.: US 2016/0326343 A1
(43) Pub. Date: Nov. 10, 2016

(54) Densified Cellulose Ester Pellets

(71) Applicant: Celanese Acetate LLC, Irving, TX (US)

(72) Inventors: Abhishek Ambekar, Florence, KY (US); Naresh Budhavaram, Florence, KY (US); Richard F. Gregory, Union, KY (US)

(21) Appl. No.: 14/707,376

(22) Filed: May 8, 2015

(51) Int. Cl. C08K 5/103; C08K 5/12

(52) U.S. Cl. CPC C08K 5/103; C08K 5/12

(57) ABSTRACT

A process for preparing densified cellulose ester pellets with reduced clumping or taking comprises mixing a cellulose ester flake or powder and plasticizer to form a blend and directing the blend to a pellet mill. The densified pellets retain the mechanical properties of the cellulose ester flake or powder. An additive may be introduced to the blend or to the pellet mill to reduce downstream compounding steps. The pellets may be stored without clumping, thus reducing processing steps and increasing yield.

### FIELD OF THE INVENTION

The present invention relates generally to processes for densifying cellulose ester flakes to form densified cellulose ester pellets having improved performance and handling characteristics. In particular, the present invention relates to blending cellulose acetate flake and plasticizer and preparing pellets from the blend.

### BACKGROUND OF THE INVENTION

The manufacture of cellulose ester and the formation of cellulose ester flake are known in the art. Generally, cellulose is acetylated, saponified, and washed with water to form flakes. The flakes are then dried to remove water. Prior to formation of products from the cellulose ester, however, the flake may be ground to a powder and then formed into pellets for easier handling and shipping. Because the cellulose ester may decompose prior to melting, a plasticizer may be added to the cellulose ester. Products incorporating cellulose esters include textiles (e g, linings, blouses, dresses, wedding and party attire, home furnishings, draperies, upholstery and slip covers), industrial uses (e.g., cigarette and other filters for tobacco products, and ink reservoirs for fiber tip pens, decking lumber), high absorbency products (e.g., diapers, sanitary napkins, and surgical products), thermoplastic products (e.g., film applications, plastic instruments, and tape), cosmetic and pharmaceutical (extended capsule/tablet release agents and encapsulating agent), medicinal (hypoallergenic surgical products) and others. Cellulose esters include but are not limited to: cellulose triacetate, cellulose diacetate (e.g., degree of substitution (DS) in the range of 2-3, and commonly known as cellulose acetate), cellulose acetates with DS<2, cellulose formates, cellulose propionates, cellulose butyrates, cellulose acetate propionates, cellulose acetate butyrates, and the like.

To form the pellets, the cellulose ester, in powder form, is combined with a plasticizer and then extruded. U.S. Pat. No. 2,758,339 discloses the extrusion of plasticized cellulose acetate by feeding a composition into a heated chamber and extruding it therefrom. The composition has a basis of plasticized cellulose acetate, said cellulose acetate containing 52.5 to 55.5% of combined acetic acid and having a viscosity in 6% by weight solution in acetone of 30-48 C.P.S. at 25° C. The composition is in particulate form, is substantially free from any volatile liquid, and contains 3-4%, ricinoleic acid, based on the weight of the cellulose acetate. The composition is extruded through an appropriately shaped orifice at a temperature from 50-70° C. at the feed point, 20-30° C. at the extrusion point, and 100-110° C. between the feed point and the extrusion point.

U.S. Pat. No. 2,761,788 discloses a composition comprising cellulose acetate plasticized with tri-(beta-monochlorethyl) phosphate and containing 1 to 5%, based on weight of the phosphate, of a member of the group consisting of the glycidyl ether of common phenol and the glycidyl ether of p-octyl phenol.

U.S. Pub. No. 2006/0267243 discloses methods of forming compounded cellulose ester comprising mixing a cellulose ester, functional additive and a swelling agent and subsequently removing at least a portion of the swelling agent. The swelling agent is one that assists in causing the functional additive to penetrate into the cellulose ester, while not acting significantly as a solvent for the cellulose ester. Preferred cellulose esters include, but are not limited to, cellulose acetates, cellulose triacetates, cellulose acetate phthalates, and cellulose acetate butyrates. The functional additive can be a plasticizer, stabilizer, or other additive selected to modify a particular property of the cellulose.

As explained in U.S. Pat. No. 4,228,276, extrusion-grade cellulose acetate powder is powder that, after the addition of a liquid plasticizer, is dry, free-flowing, and of a suitable tapped bulk density. However, when plasticizer is added to the cellulose acetate powder, the powder may clump over time, requiring either immediate extrusion of the powder once combined with plasticizer, or resulting in clogged extruder equipment and loss of powder.

The need exists for processes for producing storage stable cellulose ester pellets comprising plasticizer from cellulose ester flake. In particular, the need exists for cost effective processes for storing plasticized cellulose ester prior to compounding with improved yield.

### SUMMARY OF THE INVENTION

In a first embodiment, the present invention is directed to a process for densifying cellulose ester flake, the process comprising the steps of: a) mixing cellulose ester flake with a plasticizer to form a blend, wherein the blend comprises from 5 to 50 wt. % plasticizer; and b) feeding the blend through a pellet mill to form densified cellulose acetate pellet, wherein forming the cellulose acetate pellet generates heat; wherein the cellulose ester pellets exit the pellet mill at a temperature from 40 to 100° C.; and wherein the pellet is storage stable for at least 24 hours at room temperature and 30 to 35% humidity. The feeding of the blend through the pellet mill may be gravimetric. No heat input is used for the pellet mill. Step b) may further comprise cooling the pellet after it exits the pellet mill. The plasticizer may be selected from the group consisting of triacetin, trimethyl phosphate, triethyl phosphate, tributyl phosphate, triphenyl phosphate, triethyl citrate, acetyl trimethyl citrate, acetyl triethyl citrate, acetyl tributyl citrate, dibutyl phthalate, diaryl phthalate, diethyl phthalate, dimethyl phthalate, di-2-methoxyethyl phthalate, di-octyl phthalate (and isomers), dibutyl tartrate, ethyl o-benzoylbenzoate, ethyl phthalyl ethyl glycolate, methyl phthalyl ethyl glycolate, n-ethyltoluenesulfonamide, o-cresyl p-toluenesulfonate, aromatic diol, substituted aromatic diols, aromatic ethers, tripropionin, polycaprolactone, glycerin, glycerin esters, diacetin, polyethylene glycol, polyethylene glycol esters, polyethylene glycol diesters, di-2-ethylhexyl polyethylene glycol ester, diethylene glycol, polypropylene glycol, polyglycoldiglycidyl ethers, dimethyl sulfoxide, N-methylpyrollidinone, propylene carbonate, C₁-C₂₀ diacid esters, dimethyl adipate and other dialkyl esters, resorcinol monoacetate, catechol, catechol esters, phenols, epoxidized soy bean oil, castor oil, linseed oil, epoxidized linseed oil, other vegetable oils, other seed oils, difunctional glycidyl ether based on polyethylene glycol, alkylphosphate esters, phospholipids, aromas and combinations thereof. In some aspects, the plasticizer is selected from the group consisting of triacetin, triethyl citrate, diacetin, acetyl triethyl citrate, tributyl citrate, acetyl trihexyl citrate, butyryl trihdexyl citrate, trimethyl citrate, and combinations thereof. Density of the densified pellet may be at least 30% greater than the density of the flake. In some aspects, the densified cellulose acetate pellet may comprise from 10 to 30 wt. % plasticizer. In some aspects, the plasticizer is a non-phthalate plasticizer. Step a) may further comprising mixing an additive with the blend. The additive may be selected from the group consisting of an active particle, an antioxidant, an active compound, a nanoparticle, an abrasive particulate, an absorbent particulate, a softening agent, a flame retardant, a pigment, a dye, a flavorant, an aroma, a controlled release vesicle, a binder, an adhesive, a tackifier, a surface modification agent, a lubricating agent, an emulsifier, a vitamin, a peroxide, a biocide, an antifungal, an antimicrobial, a deodorizer, an antistatic agent, an antifoaming agent, a degradation agent, a conductivity modifying agent, a stabilizing agent, and combinations thereof. The blend may comprise from 0.1 to 5 wt. % additive. Step b) may further comprise introducing an additive into the pellet mill. In some aspects, the blend is not subjected to any drying prior to step b). In further aspects, the pellet is not subjected to any drying between steps b) and c). The blend may comprise from 0.2 to 5 wt. % moisture. In some aspects, step a) is conducted at a temperature from 25 to 80° C. The cellulose ester and the plasticizer may be mixed from 1 minute to 4 hours.

In a second embodiment, the present invention is directed to a process for densifying cellulose ester pellet, the process comprising: a) mixing cellulose ester flake having a density from 200 to 320 kg/m³ with a plasticizer to form a blend comprising from 5 to 50 wt. % plasticizer; and b) directly feeding the blend and at least one additive to a pellet mill to form a densified cellulose ester pellet having a density from 320 to 650 kg/m³, mixing cellulose ester flake having a density from 200 to 320 kg/m³ with a plasticizer to form a blend comprising from 5 to 50 wt. % plasticizer, provided that the density of the pellet is at least 30% greater than the density of the flake.

In a third embodiment, the present invention is directed to a densified cellulose ester pellet, wherein the pellet comprises from 5 to 50 wt. % plasticizer and from 50 to 95 wt. % cellulose ester, and further wherein the pellet has a density from 320 to 650 kg/m³.

### BRIEF DESCRIPTION OF THE DRAWING

The present invention will be better understood in view of the appended non-limiting figures, in which:

FIG. 1 shows a photograph of cellulose acetate flake prior to the addition of plasticizer;

FIG. 2 shows a photograph of a cellulose acetate flake blended with plasticizer according to a prior art embodiment; and

FIG. 3 shows a photograph of a densified pellet in accordance with an embodiment of the present invention.

### DETAILED DESCRIPTION OF THE INVENTION

### I. Introduction

The present invention is directed to providing storage stable plasticized cellulose ester pellets. One problem associated with cellulose esters, e.g., cellulose acetate, is that the residual moisture content in the cellulose ester may interrupt downstream compounding, e.g., extrusion of the cellulose ester. An additional problem is that once plasticizer is added to cellulose ester powder or flake, the powder or flake becomes sticky, also leading to interruptions in the compounding of the cellulose ester. These interruptions may include torque variation in the extruder, flooding of hoppers, choking of the extruder, and off-specification product. Another problem is that once plasticizer is added to the cellulose ester, the flake or powder clumps and hardens over time. Thus, before the plasticized cellulose ester can be extruded, the clumps must be broken and any remaining clumps discarded. This results in additional processing time, equipment costs, and, due to the discarded clumps, a loss in yield.

Conventionally, cellulose acetate flake was ground to form a powder, then subsequently extruded to form pellets, as opposed to directly extruding the flake to form pellets. Because the powder is often subject to clumping as plasticizer is added, the powder and plasticizer blend may require additional mixing to break clumps. One solution was to extrude the ground powder/plasticizer mixture immediately. But this placed unreasonable time restraints on the process and was not suitable for commercial scale production. Additionally, large clumps typically need to be removed from the blend, whether in powder or flake form, which requires numerous mixing steps, resulting in losses in process efficiency and/or yield.

To address these problems, the present invention forms densified pellets from the blend of plasticizer and (unground) cellulose ester flake. These densified pellets are storage stable over a broad range of plasticizers and plasticizer amounts. Because they are storage stable, the densified pellets may be fed directly to an extruder or other downstream processing step without any intervening mixing or clump removal. This results in time, cost, and energy savings, as well as an improvement in yield. It also allows for more flexibility in the process because the pellets can be prepared in large batches and stored until needed. Additionally, the pellets can contain additives that would otherwise need to be added during the compounding process. A further advantage of the densified pellets is that different batches of pellets, each including a different plasticizer, amount of plasticizer, and/or additive may be combined, and the ratios controlled, to form desired end products. For example, a first densified pellet with 15 wt. % plasticizer A can be combined in an extruder in a 2:1 ratio with a second densified pellet with 20 wt. % plasticizer B to form a product with two plasticizers in a desired ratio.

Accordingly, the present invention relates to processes for densifying cellulose ester flake, the process comprising combining cellulose ester flake with a plasticizer to form a blend; feeding the blend through a pellet mill to form cellulose ester pellets; and optionally cooling the pellets. The formation of the cellulose ester pellets generates heat due to frictional forces causing the pellets to exit the pellet mill at a temperature from 40 to 100° C. Depending on the temperature of the pellets and the desired storage conditions, the pellets may be cooled prior to storage. The pellets may then be stored until compounding or other downstream processes are performed.

### II. Cellulose Ester Flake Formation

The cellulose ester flake may be prepared by known processes, including those disclosed in U.S. Pat. No. 2,740,775 and in U.S. Publication No. 2013/0096297, the entireties of which are incorporated by reference herein. The cellulose ester may be selected from the group consisting of cellulose acetate, cellulose triacetate, cellulose acetate phthalate, cellulose acetate butyrate, cellulose butyrate, cellulose tributyrate, cellulose propionate, cellulose tripropionate, cellulose acetate propionate, carboxymethylcellulose acetate, carboxymethylcellulose acetate propionate, carboxymethylcellulose acetate butyrate, cellulose acetate butyrate succinate, and mixtures thereof. In some aspects, the cellulose ester is cellulose acetate.

Typically, acetylated cellulose is prepared by reacting cellulose with an acetylating agent in the presence of a suitable acidic catalyst. Acylating agents can include both carboxylic acid anhydrides (or simply anhydrides) and carboxylic acid halides, particularly carboxylic acid chlorides (or simply acid chlorides). Suitable acid chlorides can include, for example, acetyl chloride, propionyl chloride, butyryl chloride, benzoyl chloride and like acid chlorides. Suitable anhydrides s can include, for example, acetic anhydride, propionic anhydride, butyric anhydride, benzoic anhydride and like anhydrides. Mixtures of these anhydrides or other acylating agents can also be used in order to introduce differing acyl groups to the cellulose. Mixed anhydrides such as, for example, acetic propionic anhydride, acetic butyric anhydride and the like can also be used for this purpose in some embodiments.

In most cases, the cellulose is exhaustively acetylated with the acetylating agent to produce a derivatized cellulose having a high DS value, such as from 2.5 to 3, e.g., about 3, along with some additional hydroxyl group substitution (e.g., sulfate esters) in some cases. Exhaustively acetylating the cellulose refers to an acetylation reaction that is driven toward completion such that as many hydroxyl groups as possible in cellulose undergo an acetylation reaction.

Suitable acidic catalysts for promoting the acetylation of cellulose often contain sulfuric acid or a mixture of sulfuric acid and at least one other acid. Other acidic catalysts not containing sulfuric acid can similarly be used to promote the acetylation reaction. In the case of sulfuric acid, at least some of the hydroxyl groups in the cellulose can become initially functionalized as sulfate esters during the acetylation reaction. Once exhaustively acetylated, the cellulose is then subjected to a controlled partial de-esterification step, generally in the presence of a de-esterification agent, also referred to as a controlled partial hydrolysis step.

De-esterification, as used herein, refers a chemical reaction during which one or more of the ester groups of the intermediate cellulosic ester are cleaved from the cellulose acetate and replaced with a hydroxyl group, resulting in a cellulose acetate product having a (second) DS of less than 3. “De-esterifying agent,” as used herein, refers to a chemical agent capable of reacting with one or more of the ester groups of the cellulose acetate to form hydroxyl groups on the intermediate cellulosic ester. Suitable de-esterifying agents include low molecular weight alcohols, such as methanol, ethanol, isopropyl alcohol, pentanol, R—OH, wherein R is C₁ to C₂₀ alkyl group, and mixtures thereof. Water and a mixture of water and methanol may also be used as the de-esterifying agent. Typically, most of these sulfate esters are cleaved during the controlled partial hydrolysis used to reduce the amount of acetyl substitution. The reduced degree of substitution may range from 0.5 to 2.9, e.g., from 1.5 to 2.9 or from 2.5 to 2.9.

One of the more highly desirable attributes of acetylated cellulose prepared by the above described process is that it can be readily processed into several different forms including, for example, films, flakes, fibers (e.g., fiber tows), non-deformable solids and the like depending on its intended end use application. The number average molecular weight of the cellulose acetate may range from 40,000 amu to 100,000 amu, e.g., from 50,000 amu to 80,000 amu. The cellulose acetate may be provided in powder or flake form. The powder form of cellulose acetate may have an average particle size from 200 to 300 μm, as determined by sieve analysis. In some embodiments, at least 90% of the particles may have a diameter of less than 400 μm, at least 50% of the particles may have a diameter of less than 200 μm, and at least 10% of the particles may have a diameter of less than 70 μm.

Most often, the acetylated cellulose obtained from controlled partial hydrolysis precipitates as a flake material. When precipitated as a flake material, the cellulose ester flake may have a density from 200 to 320 kg/m³ (from approximately 14 to 20 lbs/ft³), e.g., from 210 to 300 kg/m³, or from 220 to 300 kg/m³. The flake form of cellulose acetate may have an average flake size from 5 μm to 10 mm, as determined by sieve analysis. The flake form may have less than 5 wt. % moisture, e.g., less than 3 wt. % moisture or less than 2.5 wt. % moisture. In terms of ranges, the flake form may have from 0.01 to 3 wt. % moisture, e.g., from 0.1 to 2.5 wt. % moisture or from 0.5 to 2.45 wt. % moisture. Prior to blending with a plasticizer and optionally, additives, the cellulose acetate flake may be dried to remove moisture. In some embodiments, the cellulose acetate flake may be dried until it has a moisture content of less than 2 wt. % moisture, e.g., less than 1.5 wt. %, less than 1 wt. % or less than 0.2 wt. %. The drying may be conducted at a temperature from 30 to 100° C., e.g., from 50 to 80° C. for a period of 1 to 24 hours, e.g., from 5 to 20 hours or from 10 to 15 hours. In other embodiments, the flake need not be dried prior to blending with the plasticizer, or may be partially dried and may comprise from 0.2 to 5 wt. % moisture, e.g., from 0.5 to 5 wt. % moisture, from 1 to 5 wt. % moisture or from 2 to 5 wt. % moisture.

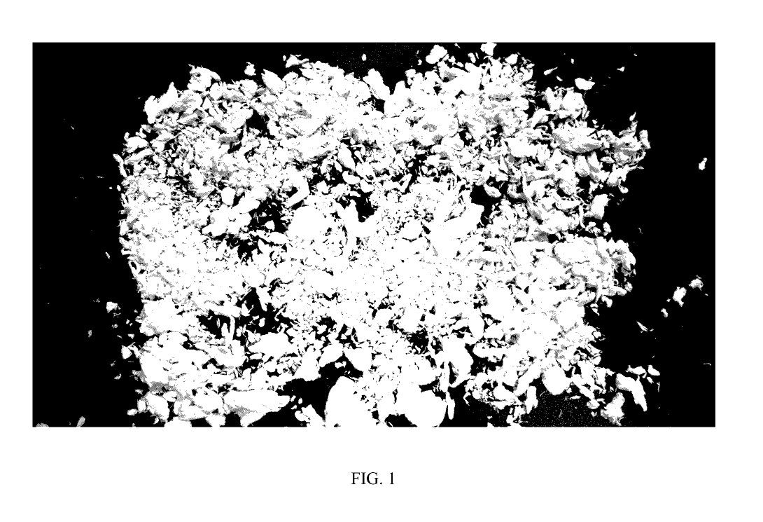

A photograph of a cellulose acetate flake is shown in FIG. 1.

### III. Cellulose Ester-Plasticizer Blend

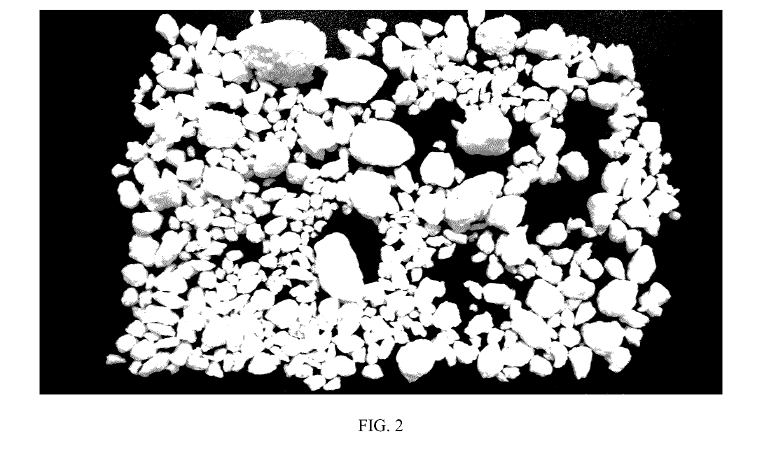

The cellulose ester flake is next combined with a plasticizer to form a blend. As discussed herein, an advantage of the present invention is that the cellulose ester flake itself is combined with the plasticizer. The cellulose ester flake need not be first ground into a powder. In prior processes, because the flake or powder was combined with plasticizer and then stored (without being formed into densified pellets), adding plasticizer to flake was avoided since the plasticized flake was highly susceptible to clumping. This is especially true for plasticizers such as triacetin and triethyl citrate when used at levels of 18 wt. % or greater, based on the total weight of the plasticized cellulose ester. Even when plasticizer was added to the powder and stored, clumping occurred, requiring mixing to break the clumps and/or removal of the clumps from the powder. A photographs of a cellulose acetate flake blended with plasticizer and stored without densification into pellet form is shown in FIG. 2. The inventors have now found that if the plasticized flake is pelletized, e.g., formed into densified pellets, after blending, the aforementioned storage and clumping problems can be lessened or avoided altogether.

Plasticizers

The plasticizer may be a cellulose plasticizer generally known to one skilled in the art, including but not limited to triacetin, trimethyl phosphate, triethyl phosphate, tributyl phosphate, triphenyl phosphate, triethyl citrate, acetyl trimethyl citrate, acetyl triethyl citrate, acetyl tributyl citrate, dibutyl phthalate, diaryl phthalate, diethyl phthalate, dimethyl phthalate, di-2-methoxyethyl phthalate, di-octyl phthalate (and isomers), dibutyl tartrate, ethyl o-benzoylbenzoate, ethyl phthalyl ethyl glycolate, methyl phthalyl ethyl glycolate, n-ethyltoluenesulfonamide, o-cresyl p-toluenesulfonate, aromatic diol, substituted aromatic diols, aromatic ethers, tripropionin, polycaprolactone, glycerin, glycerin esters, diacetin, polyethylene glycol, polyethylene glycol esters, polyethylene glycol diesters, di-2-ethylhexyl polyethylene glycol ester, diethylene glycol, polypropylene glycol, polyglycoldiglycidyl ethers, dimethyl sulfoxide, N-methylpyrollidinone, propylene carbonate, C₁-C₂₀ diacid esters, dimethyl adipate (and other dialkyl esters), resorcinol monoacetate, catechol, catechol esters, phenols, epoxidized soy bean oil, castor oil, linseed oil, epoxidized linseed oil, other vegetable oils, other seed oils, difunctional glycidyl ether based on polyethylene glycol, alkylphosphate esters, phospholipids, aromas (including some described herein, e.g., eugenol, cinnamyl alcohol, camphor, methoxy hydroxy acetophenone (acetovanillone), vanillin, and ethylvanillin), and the like, any derivative thereof, and any combination thereof.

In some aspects, the plasticizer may be a non-phthalate plasticizer. In some further aspects, the plasticizer may be selected from the group consisting of diacetin, acetyl triethyl citrate, triacetin, triethyl citrate, and combinations thereof. The plasticizer may be present from 5 to 50 wt. %, e.g., from 5 to 35 wt. %, from 10 to 30 wt. % or from 20 to 30 wt. %.

Blend Formation

The cellulose ester flake and plasticizer may be combined in any suitable mixing vessel, including a plow mixer, such as a Littleford mixer, or a pin mixer. The plow mixer may be used in batch processes while the pin mixer may be used in continuous processes. Generally, the mixing vessel is not heated or jacketed, and the mixing occurs at room temperature.

In some aspects, the cellulose ester is added to the mixing vessel first, followed by introduction of the plasticizer. The plasticizer may be added all at once, or over time, e.g., over 10 seconds, over 20 seconds, over 60 seconds, or over any amount of time less than the total mixing time.

The plasticizer may be added to the cellulose ester at a temperature from 25° C., i.e., room temperature, to 80° C., e.g., from 25° C. to 75° C., or from 25° C. to 70° C. The plasticizer and cellulose ester may be mixed together for 1 minute to 4 hours, e.g., from 1 minute to 3 hours, from 1 minute to 2 hours, or from 5 minutes to 30 minutes.

Additives

Additives may be introduced into the blend either during the mixing of the cellulose ester and the plasticizer, or after the mixing of the cellulose ester and plasticizer but prior to storage or forming the densified pellets. In some aspects, all additives are introduced prior to introducing the plasticizer to the cellulose ester. The additives may be selected from the group consisting of an active particle, an antioxidant, an active compound, a nanoparticle, an abrasive particulate, an absorbent particulate, a softening agent, a flame retardant, a pigment, a dye, a flavorant, an aroma, a controlled release vesicle, a binder, an adhesive, a tackifier, a surface modification agent, a lubricating agent, an emulsifier, a vitamin, a peroxide, a biocide, an antifungal, an antimicrobial, a deodorizer, an antistatic agent, an antifoaming agent, a degradation agent, a conductivity modifying agent, a stabilizing agent, and combinations thereof.

Active particles for use in conjunction with the present invention may be useful in actively reducing components from a fluid stream by absorption or reaction. Suitable active particles for use in conjunction with the present invention may include, but not be limited to, nano-scaled carbon particles, carbon nanotubes having at least one wall, carbon nanohorns, bamboo-like carbon nanostructures, fullerenes, fullerene aggregates, graphene, few layer graphene, oxidized graphene, iron oxide nanoparticles, nanoparticles, metal nanoparticles, gold nanoparticles, silver nanoparticles, metal oxide nanoparticles, alumina nanoparticles, magnetic nanoparticles, paramagnetic nanoparticles, superparamagnetic nanoparticles, gadolinium oxide nanoparticles, hematite nanoparticles, magnetite nanoparticles, gado-nanotubes, endofullerenes, Gd@C₆₀, core-shell nanoparticles, onionated nanoparticles, nanoshells, onionated iron oxide nanoparticles, activated carbon, ion exchange resins, desiccants, silicates, molecular sieves, silica gels, activated alumina, zeolites, perlite, sepiolite, Fuller's Earth, magnesium silicate, metal oxides, iron oxides, activated carbon, and any combination thereof.

Suitable active particles for use in conjunction with the present invention may have at least one dimension of about less than one nanometer, such as graphene, to as large as a particle having a diameter of about 5000 nanometers. Active particles for use in conjunction with the present invention may range from a lower size limit in at least one dimension of about: 0.1 nanometers, 0.5 nanometers, 1 nanometer, 10 nanometers, 100 nanometers, 500 nanometers, 1 micron, 5 microns, 10 microns, 50 microns, 100 microns, 150 microns, 200 microns, and 250 microns. The active particles may range from an upper size limit in at least one dimension of about: 5000 microns, 2000 microns, 1000 microns, 900 microns, 700 microns, 500 microns, 400 microns, 300 microns, 250 microns, 200 microns, 150 microns, 100 microns, 50 microns, 10 microns, and 500 nanometers. Any combination of lower limits and upper limits above may be suitable for use in conjunction with the present invention, wherein the selected maximum size is greater than the selected minimum size. In some embodiments, the active particles for use in conjunction with the present invention may be a mixture of particle sizes ranging from the above lower and upper limits. In some embodiments of the present invention, the size of the active particles may be polymodal.

Antioxidants for use in conjunction with the present invention may include a phosphite anitoxidant, amine anitoxidant, phenolic anitoxidant, and mixtures thereof. Phosphite antioxidants may include trinonylphenyl phosphate which is sold under the commercial name Irgafos® TNPP by BASF, tris-tert-butylphenyl phosphite, tridecylphosphite, triphenylphosphite, trioctylphosphite, alkylphenylphosphite, tris(alkylphenyl)phosphate, dilaurylphosphite, bis-(2,4-di-t-butylphenol)pentaerythritol diphosphite, which is sold under the commercial name Iragfos® 126 by BASF. Amine anitoxidants may include secondary aromatic amines such as diarylamines, e.g., diphenylamine, and modifieddiarylamines, e.g., N-phenyl-g-naphthylamine, p-isopropoxydiphenylamine, mono and dioctyldiphenylamine, bis-diarylamines and modified bisdiarylamines, such as N,N-diphenyl-p-phenyldiamine. Phenolic antioxidants may include iodiethylene bis(3,5-di-tert-alkyl-4-hydroxyhydrocinnamates, more preferably thiodiethylene bis(3,5-di-tert-butyl-4-hydroxyhydrocinnamate which is sold under the commercial name Irganox® 1035 by BASF, and tetrakis[methylene(3,5-di-tert-alkyl-4-hydroxyhydrocinnamate)]methanes, more preferably tetrakis[methylene(3,5-di-tert-butyl-4-hydroxyhydrocinnamate)]methane which is sold under the commercial name Irganox® 1010 by BASF. The antioxidant may be added in an amount from 0.1 to 1.5 wt. %, e.g., from 0.1 to 1 wt. % or from 0.1 to 0.5 wt. %, based on the total weight of the blend.

Active compounds for use in conjunction with the present invention may be useful in actively reducing components from a fluid stream by absorption or reaction. Suitable active compounds for use in conjunction with the present invention may include, but not be limited to, malic acid, potassium carbonate, citric acid, tartaric acid, lactic acid, ascorbic acid, polyethyleneimine, cyclodextrin, sodium hydroxide, sulphamic acid, sodium sulphamate, polyvinyl acetate, carboxylated acrylate, or any combination thereof.

Abrasive particulates may be selected from the group consisting of silicon carbide, boron carbide, fused aluminum oxide, flint, pumice, Carborundum, emery, rouge and combinations thereof.

Absorbent particulates may include sodium polyacrylate, starch graved copolymers of polyacrylonitriles, polyvinyl alcohol copolymers, cross-linked poly(ethylene oxides), polyacrylamide copolymers, ethylene maleic anhydride copolymers, cross-linked carboxymethylcelluloses, and the like, or any combination thereof. By way of nonlimiting example, superabsorbent materials incorporated into a nonwoven may be useful in chemical spill rags and kits.

Softening agents may be include water, glycerol triacetate (triacetin), triethyl citrate, dimethoxy-ethyl phthalate, dimethyl phthalate, diethyl phthalate, methyl phthalyl ethyl glycolate, o-phenyl phenyl-(bis) phenyl phosphate, 1,4-butanediol diacetate, diacetate, dipropionate ester of triethylene glycol, dibutyrate ester of triethylene glycol, dimethoxyethyl phthalate, triethyl citrate, triacetyl glycerin, and the like, any derivative thereof, and any combination thereof.

Flame retardants are disclosed in the art and may include oxyphosphorus flame retardants, nitrogen flame retardants, and combinations thereof. Suitable oxyphosphorus flame retardant compounds may comprise tributyl phosphate, triisobutyl phosphate, tris(2-butoxyethyl) phosphate, triphenyl phosphate; tri(4-methylphenyl)phosphate; tri(2,6-dimethylphenyl)phosphate; tri(2,4,6-trimethylphenyl)phosphate; tri(2,4-ditertiary butylphenyl)phosphate; tri(2,6-ditertiary butylphenyl)phosphate; isopropylphenyl diphenyl phosphate; 2-isopropylphenyl phosphate; 3-isopropylphenyl phosphate; 4-isopropylphenyl phosphate; resorcinol bis(diphenyl phosphate); bisphenol A bis(diphenyl phosphate); resorcinol bis(dixylenyl phosphate); hydroquinol bis(diphenyl phosphate); resorcinol bis-(di-2,6-dimethylphenyl phosphate); and 4,4′-biphenyl bis-(di-2,6-dimethylphenylphosphate). The nitrogen flame retardant compound may be selected from the group consisting of (i) melamine cyanurate, (ii) condensation products of melamine, (iii) reaction products of phosphoric acid with melamine, and (iv) reaction products of phosphoric acid with condensation products of melamine. Specific nitrogen flame retardant compounds include melamine cyanurate, melamine phosphate, melamine pyrophosphate, melamine orthophosphate, melem polyphosphate, melam polyphosphate, diammoniumphosphate, monoammonium phosphate, phosphoric acid amide, and melamine polyphosphate. Preferably, the nitrogen flame retardant compound is melamine cyanurate. Melamine cyanurate is sold under the commercial name Melapur® MC50 by BASF. Further flame retardants include other inorganic flame retardants, such as metal hydroxides, such as aluminum hydroxide, calcium hydroxide, zinc hydroxide, or magnesium hydroxide, or metal oxides, such as diantimony trioxide.

Suitable nanoparticles for use in conjunction with the present invention may include, but not be limited to, nano-scaled carbon particles like carbon nanotubes of any number of walls, carbon nanohorns, bamboo-like carbon nanostructures, fullerenes and fullerene aggregates, and graphene including few layer graphene and oxidized graphene; metal nanoparticles like gold and silver; metal oxide nanoparticles like alumina, silica, and titania; magnetic, paramagnetic, and superparamagentic nanoparticles like gadolinium oxide, various crystal structures of iron oxide like hematite and magnetite, about 12 nm Fe₃O₄, gado-nanotubes, and endofullerenes like Gd@C₆₀; and core-shell and onionated nanoparticles like gold and silver nanoshells, onionated iron oxide, and others nanoparticles or microparticles with an outer shell of any of said materials; and any combination of the foregoing. It should be noted that nanoparticles may include nanorods, nanospheres, nanorices, nanowires, nanostars (like nanotripods and nanotetrapods), hollow nanostructures, hybrid nanostructures that are two or more nanoparticles connected as one, and non-nano particles with nano-coatings or nano-thick walls. It should be further noted that nanoparticles for use in conjunction with the present invention may include the functionalized derivatives of nanoparticles including, but not limited to, nanoparticles that have been functionalized covalently and/or non-covalently, e.g., pi-stacking, physisorption, ionic association, van der Waals association, and the like. Suitable functional groups may include, but not be limited to, moieties comprising amines (1°, 2°, or 3°), amides, carboxylic acids, aldehydes, ketones, ethers, esters, peroxides, silyls, organosilanes, hydrocarbons, aromatic hydrocarbons, and any combination thereof; polymers; chelating agents like ethylenediamine tetraacetate, diethylenetriaminepentaacetic acid, triglycollamic acid, and a structure comprising a pyrrole ring; and any combination thereof.

As used herein, pigments refer to compounds and/or particles that impart color and are incorporated throughout the filaments. Suitable pigments for use in conjunction with the present invention may include, but not be limited to, titanium dioxide, silicon dioxide, carbon black, tartrazine, E102, phthalocyanine blue, phthalocyanine green, quinacridones, perylene tetracarboxylic acid di-imides, dioxazines, perinones disazo pigments, anthraquinone pigments, carbon black, metal powders, iron oxide, ultramarine, calcium carbonate, kaolin clay, aluminum hydroxide, barium sulfate, zinc oxide, aluminum oxide, caramel, fruit or vegetable or spice colorants (e.g., beet powder, beta-carotene, turmeric, paprika), or any combination thereof.

Suitable flavorants for use in conjunction with the present invention may include, but not be limited to, organic material (or naturally flavored particles), carriers for natural flavors, carriers for artificial flavors, and any combination thereof. Organic materials (or naturally flavored particles) include, but are not limited to, tobacco, cloves (e.g., ground cloves and clove flowers), cocoa, and the like. Natural and artificial flavors may include, but are not limited to, menthol, cloves, cherry, chocolate, orange, mint, mango, vanilla, cinnamon, tobacco, and the like. Such flavors may be provided by menthol, anethole (licorice), anisole, limonene (citrus), eugenol (clove), and the like, or any combination thereof. In some embodiments, more than one flavorant may be used including any combination of the flavorants provided herein.

Suitable aromas for use in conjunction with the present invention may include, but not be limited to, methyl formate, methyl acetate, methyl butyrate, ethyl acetate, ethyl butyrate, isoamyl acetate, pentyl butyrate, pentyl pentanoate, octyl acetate, myrcene, geraniol, nerol, citral, citronellal, citronellol, linalool, nerolidol, limonene, camphor, terpineol, alpha-ionone, thujone, benzaldehyde, eugenol, cinnamaldehyde, ethyl maltol, vanilla, anisole, anethole, estragole, thymol, furaneol, methanol, or any combination thereof.

Suitable binders for use in conjunction with the present invention may include, but not be limited to, polyolefins, polyesters, polyamides (or nylons), polyacrylics, polystyrenes, polyvinyls, polytetrafluoroethylene (PTFE), polyether ether ketone (PEEK), any copolymer thereof, any derivative thereof, and any combination thereof. Non-fibrous plasticized cellulose derivatives may also be suitable for use as binder particles in the present invention. Examples of suitable polyolefins may include, but not be limited to, polyethylene, polypropylene, polybutylene, polymethylpentene, and the like, any copolymer thereof, any derivative thereof, and any combination thereof. Examples of suitable polyethylenes may include, but not be limited to, ultrahigh molecular weight polyethylene, very high molecular weight polyethylene, high molecular weight polyethylene, low-density polyethylene, linear low-density polyethylene, high-density polyethylene, and the like, any copolymer thereof, any derivative thereof, and any combination thereof. Examples of suitable polyesters may include, but not be limited to, polyethylene terephthalate, polybutylene terephthalate, polycyclohexylene dimethylene terephthalate, polytrimethylene terephthalate, and the like, any copolymer thereof, any derivative thereof, and any combination thereof. Examples of suitable polyacrylics may include, but not be limited to, polymethyl methacrylate, and the like, any copolymer thereof, any derivative thereof, and any combination thereof. Examples of suitable polystyrenes may include, but not be limited to, polystyrene, acrylonitrile-butadiene-styrene, styrene-acrylonitrile, styrene-butadiene, styrene-maleic anhydride, and the like, any copolymer thereof, any derivative thereof, and any combination thereof. Examples of suitable polyvinyls may include, but not be limited to, ethylene vinyl acetate, ethylene vinyl alcohol, polyvinyl chloride, and the like, any copolymer thereof, any derivative thereof, and any combination thereof. Examples of suitable cellulosics may include, but not be limited to, cellulose acetate, cellulose acetate butyrate, plasticized cellulosics, cellulose propionate, ethyl cellulose, and the like, any copolymer thereof, any derivative thereof, and any combination thereof. In some embodiments, binder particles may comprise any copolymer, any derivative, or any combination of the above listed binders. Further, binder particles may be impregnated with and/or coated with any combination of additives disclosed herein.

Suitable tackifiers for use in conjunction with the present invention may include, but not be limited to, methylcellulose, ethylcellulose, hydroxyethylcellulose, carboxy methylcellulose, carboxy ethylcellulose, water-soluble cellulose acetate, amides, diamines, polyesters, polycarbonates, silyl-modified polyamide compounds, polycarbamates, urethanes, natural resins, shellacs, acrylic acid polymers, 2-ethylhexylacrylate, acrylic acid ester polymers, acrylic acid derivative polymers, acrylic acid homopolymers, anacrylic acid ester homopolymers, poly(methyl acrylate), poly(butyl acrylate), poly(2-ethylhexyl acrylate), acrylic acid ester co-polymers, methacrylic acid derivative polymers, methacrylic acid homopolymers, methacrylic acid ester homopolymers, poly(methyl methacrylate), poly(butyl methacrylate), poly(2-ethylhexyl methacrylate), acrylamido-methyl-propane sulfonate polymers, acrylamido-methyl-propane sulfonate derivative polymers, acrylamido-methyl-propane sulfonate co-polymers, acrylic acid/acrylamido-methyl-propane sulfonate co-polymers, benzyl coco di-(hydroxyethyl) quaternary amines, p-T-amyl-phenols condensed with formaldehyde, dialkyl amino alkyl (meth)acrylates, acrylamides, N-(dialkyl amino alkyl) acrylamide, methacrylamides, hydroxy alkyl (meth)acrylates, methacrylic acids, acrylic acids, hydroxyethyl acrylates, and the like, any derivative thereof, or any combination thereof.

Suitable lubricating agents for use in conjunction with the present invention may include, but not be limited to, ethoxylated fatty acids (e.g., the reaction product of ethylene oxide with pelargonic acid to form poly(ethylene glycol) (“PEG”) monopelargonate; the reaction product of ethylene oxide with coconut fatty acids to form PEG monolaurate), and the like, or any combination thereof. The lubricant agents may also be selected from nonwater-soluble materials such as synthetic hydrocarbon oils, alkyl esters (e.g., tridecyl stearate which is the reaction product of tridecyl alcohol and stearic acid), polyol esters (e.g., trimethylol propane tripelargonate and pentaerythritol tetrapelargonate), and the like, or any combination thereof.

Suitable emulsifiers for use in conjunction with the present invention may include, but not be limited to, sorbitan monolaurate, e.g., SPAN® 20 (available from Uniqema, Wilmington, Del.), or poly(ethylene oxide) sorbitan monolaurate, e.g., TWEEN® 20 (available from Uniqema, Wilmington, Del.).

Suitable vitamins for use in conjunction with the present invention may include, but not be limited to, vitamin B compounds (including B1 compounds, B2 compounds, B3 compounds such as niacinamide, niacinnicotinic acid, tocopheryl nicotinate, C1-C.sub.18 nicotinic acid esters, and nicotinyl alcohol; B5 compounds, such as panthenol or “pro-B5”, pantothenic acid, pantothenyl; B6 compounds, such as pyroxidine, pyridoxal, pyridoxamine; carnitine, thiamine, riboflavin); vitamin A compounds, and all natural and/or synthetic analogs of Vitamin A, including retinoids, retinol, retinyl acetate, retinyl palmitate, retinoic acid, retinaldehyde, retinyl propionate, carotenoids (pro-vitamin A), and other compounds which possess the biological activity of Vitamin A; vitamin D compounds; vitamin K compounds; vitamin E compounds, or tocopherol, including tocopherol sorbate, tocopherol acetate, other esters of tocopherol and tocopheryl compounds; vitamin C compounds, including ascorbate, ascorbyl esters of fatty acids, and ascorbic acid derivatives, for example, ascorbyl phosphates such as magnesium ascorbyl phosphate and sodium ascorbyl phosphate, ascorbyl glucoside, and ascorbyl sorbate; and vitamin F compounds, such as saturated and/or unsaturated fatty acids; or any combination thereof.

Suitable antimicrobials for use in conjunction with the present invention may include, but not be limited to, anti-microbial metal ions, chlorhexidine, chlorhexidine salt, triclosan, polymoxin, tetracycline, amino glycoside (e.g., gentamicin), rifampicin, bacitracin, erythromycin, neomycin, chloramphenicol, miconazole, quinolone, penicillin, nonoxynol 9, fusidic acid, cephalosporin, mupirocin, metronidazolea secropin, protegrin, bacteriolcin, defensin, nitrofurazone, mafenide, acyclovir, vanocmycin, clindamycin, lincomycin, sulfonamide, norfloxacin, pefloxacin, nalidizic acid, oxalic acid, enoxacin acid, ciprofloxacin, polyhexamethylene biguanide (PHMB), PHMB derivatives (e.g., biodegradable biguanides like polyethylene hexamethylene biguanide (PEHMB)), clilorhexidine gluconate, chlorohexidine hydrochloride, ethylenediaminetetraacetic acid (EDTA), EDTA derivatives (e.g., disodium EDTA or tetrasodium EDTA), and the like, and any combination thereof.

Antistatic agents (antistats) for use in conjunction with the present invention may comprise any suitable anionic, cationic, amphoteric or nonionic antistatic agent. Anionic antistatic agents may generally include, but not be limited to, alkali sulfates, alkali phosphates, phosphate esters of alcohols, phosphate esters of ethoxylated alcohols, or any combination thereof. Examples may include, but not be limited to, alkali neutralized phosphate ester (e.g., TRYFAC® 5559 or TRYFRAC® 5576, available from Henkel Corporation, Mauldin, S.C.). Cationic antistatic agents may generally include, but not be limited to, quaternary ammonium salts and imidazolines which possess a positive charge. Examples of nonionics include the poly(oxyalkylene) derivatives, e.g., ethoxylated fatty acids like EMEREST® 2650 (an ethoxylated fatty acid, available from Henkel Corporation, Mauldin, S.C.), ethoxylated fatty alcohols like TRYCOL® 5964 (an ethoxylated lauryl alcohol, available from Henkel Corporation, Mauldin, S.C.), ethoxylated fatty amines like TRYMEEN® 6606 (an ethoxylated tallow amine, available from Henkel Corporation, Mauldin, S.C.), alkanolamides like EMID® 6545 (an oleic diethanolamine, available from Henkel Corporation, Mauldin, S.C.), or any combination thereof. Anionic and cationic materials tend to be more effective antistats.

Stabilizing agents may include stabilize color and include heat (thermal) stabilizers and UV stabilizers. The heat stabilizers may be selected from the group consisting of radical scavengers, radical terminators, metal scavengers, peroxide decomposers, and metal salts. More specifically, thermal stabilizers may include compounds selected from the group of hindered phenols, hindered amines, epoxides of natural oils, organic phosphites, and mixtures thereof. Some preferred thermal stabilizers include those sold under the names Irganox®, Irgafos®, and Irgastab® (available from Ciba). Stabilizing metal agents may be selected from the group of alkali and alkaline metal salts, including salts of lithium, sodium, potassium, rubidium, cesium, beryllium, magnesium, calcium, strontium, and barium. Suitable inorganic and organic acid salts of alkali and alkaline metals include, but are not limited to, the hydroxides, carbonates, hydrogen carbonates, citrates, lactates, tartrates, maltates, oxylates, phosphates, acetates, propionates, etc., and mixtures thereof. Thermal stabilizers are typically present at levels of from about 0.05% to about 5% by weight, and preferably from about 0.1% to about 2% by weight, based upon the total weight of the blend. The UV stabilizers may be selected from the group consisting of benzotriazoles, triazines, hydroxybenzophenone, benzoxazinone, resorcinol monobenzoates, salicylic esters (e.g., 2,6-dialkylphenyl salicylate), p-octylphenyl salicylate, cinnamic derivatives, oxanilides, hydroxybenzoic esters, sterically hindered triazines, sterically hindered amine light scavengers (HALS), compounds in the Tinuvin®, Chimassorb®, Cyasorb® (available from Ciba) and Univul™ (available from BASF) product series, and mixtures thereof. UV absorbers and stabilizers are typically present at about 0.01 to about 5% by weight, based upon the total weight of the blend.

Examples of suitable indicators for use in the present invention include pH indicators, moisture indicators, redox indicators, and temperature indicators. Examples of suitable pH indicators include those selected from the group consisting of phenolphthalein, litmus, thymol blue, tropeolin 00, methyl yellow, methyl orange, bromophenol blue, bromocresol green, methyl red, bromothymol blue, phenol red, neutral red, thymolphthalein, alizarin yellow, tropeolin 0, nitramine, and trinitrobenzoic acid. An example of a moisture indicator is cobalt chloride. Examples of temperature indicators include thermochromic dyes, such as indoine blue, spiropyran derivatives. Examples of suitable redox indicators include those selected from the group consisting of ferroin, iodine/starch, bis(4-dialkylaminophenyl)squaraine dyes, KMnO₄, and K₂Cr₂O₇.

Examples of insecticides include those selected from the group consisting of organochlorine compounds, organophosphate compounds, aryl compounds, heterocyclic compounds, organosulfur compounds, carbamate compounds, formamidine compounds, dinitrophenol compounds, organotin compounds, pyrethroid compounds, acylurea compounds, botanical compounds, antibiotic compounds, fumigant compounds, repellant compounds, inorganic compounds, and mixtures thereof.

These additives are generally added during the compounding process but in the inventive process, advantageously, the additives may be introduced during the mixing step, thus consolidating the process and reducing costs. Another benefit of introducing the additives during the mixing step may be improved accuracy of additive content in the final product, since little to no additive is lost during the compounding process, particularly as compared to compounding processes where mixing may be incomplete. In still further embodiments, some additives may be added during the blend formation while other additives may be added during densification or during downstream compounding processes. The total amount of additives included in the blend may range from 0.1 to 5 wt. %, e.g., from 0.5 to 5 wt. % or from 1 to 5 wt. %, based on the total weight of the blend.

### IV. Densified Pellet Formation

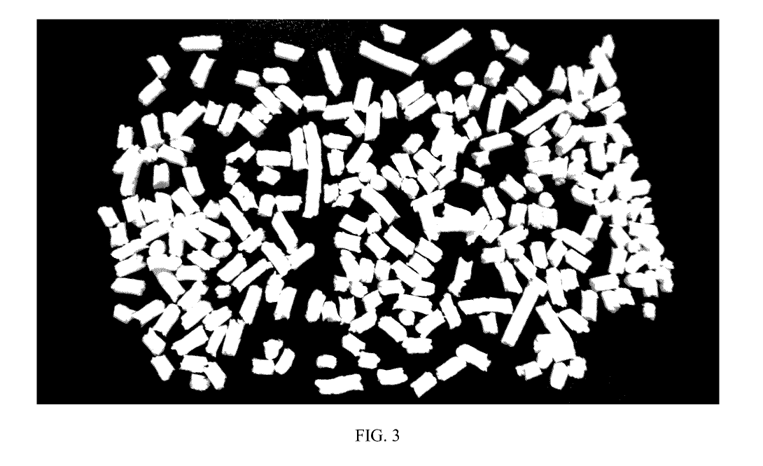

Once the cellulose ester flake has been combined with plasticizer as described above to form the blend, the blend is directed to a pellet mill to form a densified pellet. The pelletization of the blend provides for the storage and anti-clumping benefits previously mentioned. A photograph of a densified pellet is shown in FIG. 3. The process of densifying the blend into a pellet lowers the volume to weight ratio of the blend and improves the feeding of the blend for downstream processing. The pellet mill may be any commercially available pellet mill, such as a Kahl pelleting press. The pellet mill may comprise an inlet which allows for the gravimetric flow of the blend through the pellet mill. The pellet mill also comprises a grinder roller and a die. The die may have a diameter from 1 to 5 mm. The die may have a compression ratio from 1:1 to 5:1. The diameter defines the diameter of the final pellet and the compression ratio defines the hardness of the pellet. If the pellet is too soft, it will break while storing. If the pellet is too hard, it will generate too much heat during the pelletizing process, making the process more difficult.

The blend may be fed to the pellet mill at room temperature, or at a temperature from 25 to 50° C. Because the pelletizing generates heat, the pellets exit the pellet mill at a temperature from 40 to 100° C., and may optionally be cooled prior to storage. If the pellets are cooled prior to storage, they may be cooled to a temperature of less than 35° C., e.g., from 25 to 35° C.

In some embodiments, the blend is sent directly to the pellet mill, without any intervening processing. Generally, in a batch process, the time between forming the blend and directing the blend to the pellet mill is from 30 minutes to 60 minutes. However, in some aspects, depending on the plasticizer and the amount of plasticizer included in the blend, the blend may be stored for up to 24 hours without clumping. In a continuous process, the blend may be directly fed to the pellet mill. Because the blend is directed to the pellet mill prior to any clumping, no clumps need to be remixed, broken up or removed. This results in an improved yield of pellet from the blend, e.g., a yield of at least 80%, e.g., at least 90%, at least 95%, or at least 98%.

Additional components may be added during the densification step, which is yet another advantage of the present invention. In typical processes, these additives would be introduced during compounding steps, wherein the powder or flake is melted at temperatures from 200 to 220° C. One or more of the additives disclosed in Section III may be added to the pellet mill so that the densified pellets contain the one or more additives. Thus, the compounding steps and equipment, including mixers, may be reduced by incorporating the additives into the densified pellet.

In some embodiments, the densified pellet may have a density from 320 to 650 kg/m³, e.g., from 350 to 550 kg/m³, or from 400 to 550 kg/m³. The density of the densified pellet may be at least 30% greater than the density of the cellulose acetate flake from which it was formed, e.g., at least 40% greater or at least 50% greater. In terms of ranges, the density of the pellet may be from 30 to 80% greater than the cellulose acetate flake from which it was formed, e.g., from 40 to 80% greater or from 50 to 80% greater. By increasing the density of the flake by forming a pellet, the pellet is storage stable and may be more easily handled.

Once formed, the densified pellet is storage stable and need not be immediately extruded or shaped. For example, the densified pellet is storage stable for at least 24 hours, at least one week, at least one month, at least three months, or at least six months. “Storage stable” is understood to mean that less than 5 wt. % of the pellets clump over the set time period, when stored at room temperature (e.g., 25° C.) and 30-35% humidity, e.g., less than 3 wt. %, less than 1 wt. % or less than 0.5%. Clumping is understood to refer to pellets binding together and forming a larger mass, wherein the average diameter of the pellet is increased. For example, a determination of whether the pellets are clumped may be made by measuring the diameter of the pellets before and after storage. If the diameter of the pellet has increased by more than 15%, e.g., more than 20% or more than 25% in size, then clumping has occurred. Generally, the pellets have a diameter of 10 mm or less, e.g., less than 8 mm or less than 7 mm. Thus, if a pellet had an initial diameter of 8 mm and after storage has a diameter of 11 mm, clumping has occurred. Assuming that a pellet has a minimum dimension, such as a width, and a maximum dimension, such as a length, the diameter for a pellet is measured from the minimum average dimension. The size determination for the diameter of the pellet is selected based on the equipment used in the compounding steps, e.g., the extruder. Depending on the end use of the densified pellet, the pellet may be subjected to compounding, extruding, injection molding and other downstream treatments to form a final product.

The present invention will be better understood in view of the following non-limiting examples.

### V. Examples

### Example 1

Example 1 was prepared as follows. Cellulose acetate (CA) flakes and triacetin as a plasticizer were mixed together for 5 minutes to form a mixture comprising 26 wt. % triacetin and 74 wt. % cellulose acetate by using a 130 L Littleford mixer. The blending batch size was 50 lbs (22.68 kg). The cellulose acetate flakes were charged into the mixer first and the triacetin was then added through a funnel over 60 seconds. A well-mixed blend was observed after 5 minutes of mixing time. This mixture was then hand fed into a Kahl pellet mill using a die with a diameter of 3 mm, a die pressure of 8000 kPa, and a compression ratio of 5:1. The pellets were collected into trays and cooled at ambient temperature to 32° C. before packaging in a bag. The pellets were not passed through a fluidized bed. Minor sticking was observed. The experimental conditions are shown in Table 1.

### Example 2

The pellets were prepared as in Example 1, except that the compression ratio was 3:1 and the pellets were cooled to a temperature of 16° C. by passing the pellets through a fluidized bed. No sticking was observed. The experimental conditions are shown in Table 1.

### Examples 3-6

The pellets were prepared as in Example 1, except that the plasticizer type, weight percent and/or compression ratio were changed as shown in Table 1.

TABLE 1
Experimental Conditions for Examples 1-7

| | | | | | | Die | Gap in | |
|---|---|---|---|---|---|---|---|---|
| | | Plasticizer | Diameter of | Compression | | Pressure | Die and | Temp. |
| Ex. | Plasticizer | (wt. %) | Die (mm) | Ratio | Knife | (kPa) | Knife | (° C.) |
| 1 | Triacetin | 26 | 3 | 5:1 | Thick | 8000 | Away | 74 |
| 2 | Triacetin | 26 | 3 | 3:1 | Thick | 8000 | Away | 52 |
| 3 | Triacetin | 26 | 3 | 3:1 | Thick | 8000 | Close | 63 |
| 4 | Triethyl | 26 | 3 | 3:1 | Thick | 8000 | Away | 60 |
| | Citrate | | | | | | | |
| 5 | Triethyl | 30 | 3 | 3:1 | Thick | 8000 | Away | 49 |
| | Citrate | | | | | | | |
| 6 | Triethyl | 26 | 3 | 3:1 | Thick | 8000 | Away | 54 |
| | Citrate | | | | | | | |
| 7 | Triethyl | 22 | 3 | 3:1 | Thick | 8000 | Away | 59 |
| | Citrate | | | | | | | |

No sticking was observed for Examples 2-4, 6 and 7. Slight sticking was observed for Example 5 after several days of storage, but this is believed to be due to the greater amount of plasticizer in Example 5 as compared to the other examples. However, the slight sticking still allowed acceptable yield, e.g., at least 97%.

### Example 8

Example 8 was prepared as follows. Cellulose acetate (CA) flakes and diacetin as a plasticizer were mixed together to form a mixture comprising 22 wt. % diacetin and 78 wt. % cellulose acetate. The cellulose acetate flakes and diacetin were added to a mixer at room temperature and mixed for 1 minute to form a blend. The blend was then hand fed into a Kahl pellet mill using a die with a diameter of 3 mm, a die pressure of 8000 kPa, and a compression ratio of 5:1. The pellets were collected into trays and cooled down to 32° C. before packaging in a bag. The pellets were not passed through a fluidized bed.

### Example 9

Example 9 was prepared using the same process of Example 8, except that an antioxidant was added.

### Example 10

Example 10 was prepared using the same process as Example 9, except that the blend comprised 12 wt. % diacetin and 12 wt. % acetyl triethyl citrate as plasticizers.

### Example 11

Example 11 was prepared using the same process as Example 8, except the blend comprised 26 wt. % acetyl triethyl citrate as the plasticizer.

### Example 12

Example 12 was prepared using the same process as Example 8, except that the cellulose acetate and plasticizer were mixed for 2 hours at a temperature of 80° C. to form the blend. Once the pellet was formed, the pellet was mixed with an antioxidant. The pellet was then directly injection molded.

### Comparative Example A

Comparative Example A was prepared as follows. Diacetin was added to cellulose acetate flake at a temperature of 80° C. and the components were mixed for 4 hours to form a blend comprising 22 wt. % diacetin and 78 wt. % cellulose acetate. The blend was not fed to a pellet mill and thus remained in flake form. Comparative Example A is similar to Example 8, except that it remains in flake form.

### Comparative Example B

Comparative Example B was prepared using the same process as Comparative Example A, except that an antioxidant was added to the blend. Comparative Example B is similar to Example 9, except that it remains in flake form.

### Comparative Example C

Comparative Example C was prepared using the same process as Comparative Example A, except that the plasticizer was acetyl triethyl citrate and the blend comprised 26 wt. % acetyl triethyl citrate. Comparative Example C is similar to Example 11, except that it remains in flake form.

### Comparative Example D

Comparative Example D was prepared using the same process as Comparative Example B, except that the cellulose acetate flake was a commercially available flake purchased from a pulp supplier. Comparative Example D is similar to Example 12, except that it remains in flake form.

### Testing of Examples 8-12 and Comparative Examples A-D

The tensile modulus and flex modulus for each of Examples 8-12 and Comparative Examples A-D were tested in accordance with ISO 527 (2012) and ISO 178 (2010), respectively. The results are shown in Table 2. As indicated by the results, forming a densified pellet did not appreciably affect the tensile modulus or flex modulus of the cellulose acetate/plasticizer blend, pellet, or shaped object prepared therefrom.

The tensile strength (break stress) and flexural strength (stress as 3.5%) for each of Examples 8-12 and Comparative Examples A-D were tested in accordance with ISO 178 (2010). The results are shown in Table 2. As indicated by the results, forming a densified pellet did not appreciably affect the tensile strength or flexural strength of the cellulose acetate/plasticizer blend, pellet, or shaped object prepared therefrom.

The elongation at break for each of Examples 8-12 and Comparative Examples A-D was tested in accordance with ISO 527 (2012). The results are shown in Table 2. As indicated by the results, forming a densifled pellet did not appreciably affect the elongation at break of the cellulose acetate/plasticizer blend, pellet, or shaped object prepared therefrom.

The strain rate for each of Examples 9-14 and Comparative Examples A-D was tested by using the Notched Charpy test in accordance with ISO 179-1 (2010). The results are shown in Table 2. As indicated by the results, forming a densified pellet did not appreciably affect the strain rate of the cellulose acetate/plasticizer blend, pellet, or shaped object prepared therefrom.

The deflection temperature under load (DTUL) for each of Examples 8-12 and Comparative Examples A-D was tested at 1.8 MPA. The DTUL for each of Examples 8-12 and Comparative Examples A-D was tested at 0.45 MPA. The DTUL was tested in accordance with ISO 75 (2013). The results are shown in Table 2. As indicated by the results, forming a densified pellet did not appreciably affect the DTUL of the cellulose acetate/plasticizer blend, pellet, or shaped object prepared therefrom.

The melt flow index at 210° C. for each of Examples 8-11 and Comparative Examples A-D was tested in accordance with ISO 1133 (2011). The results are shown in Table 2. As indicated by the results, forming a densified pellet did not appreciably affect the melt flow index of the cellulose acetate/plasticizer blend, pellet, or shaped object prepared therefrom.

TABLE 2
Testing Results for Examples 8-12 and Comparative Examples A-D

| Example | Comp. A | 8 | Comp. B | 9 | Comp. C | 11 | Comp. D | 12 | 10 |
|---|---|---|---|---|---|---|---|---|---|
| Tensile Modulus | 3655 | 3849 | 3513 | 3760 | 2453 | 2600 | 3444 | 2969 | 2678 |
| (MPa) | | | | | | | | | |
| Flex Modulus | 4027 | 3913 | 3739 | 3805 | 2599 | 2663 | 3755 | 3227 | 2935 |
| (MPa) | | | | | | | | | |
| Tensile Strength | 74 | 73.69 | 66.7 | 69.53 | 58.63 | 59.03 | 77.13 | 52.45 | 59.64 |
| (MPa) | | | | | | | | | |
| Flexural Strength | 82.03 | 81.11 | 77.08 | 77.59 | 62.16 | 64.95 | 61.37 | 60.06 | 66.33 |
| at 3.5% (MPa) | | | | | | | | | |
| Elongation at | 3.39 | 2.87 | 2.48 | 2.51 | 14.12 | 5.68 | 2.06 | 2.35 | 3.52 |
| Break (%) | | | | | | | | | |
| Notched Charpy | 5.7 | 5.9 | 5.9 | 5.9 | 6.7 | 5.3 | 5.3 | 6.9 | 7.4 |
| (kJ/m²) | | | | | | | | | |
| DTUL at 1.8 | 76.4 | 74.7 | 75.6 | 69.5 | 63.3 | 67 | 69.5 | 59.8 | |
| MPa (° C.) | | | | | | | | | |
| DTUL at 0.45 | 93.5 | 88.8 | 90.8 | 88.4 | 85.3 | 86.8 | 86 | — | |
| MPa (° C.) | | | | | | | | | |
| Melt Flow Index | 1.12 | 1.33 | 1.59 | 3.41 | 1.37 | 1.59 | 1.98 | — | 1.71 |
| at 210° C. (grams | | | | | | | | | |
| polymer/10 | | | | | | | | | |
| minutes) | | | | | | | | | |

### Example 13

Example 13 was prepared using the same process of Example 8, except that the blend comprised 28 wt. % diethyl phthalate as the plasticizer, and the plasticizer and cellulose acetate were mixed at 80° C. for 4 hours.

### Example 14

Example 14 was prepared using the same process of Example 13, except that the cellulose acetate flake was not dried and had a moisture content from 2 to 5 wt. %.

### Example 15

Example 15 was prepared using the same process of Example 8, except that the blend comprised 28 wt. % diethyl phthalate as the plasticizer an antioxidant was added to the blend.

### Example 16

Example 16 was prepared using the same process as Example 8, except that the blend comprised 28 wt. % diethyl phthalate as the plasticizer and the cellulose acetate flake was not dried and had a moisture content from 2 to 5 wt. %.

### Example 17

Example 17 was prepared using the same process as Example 8, except that the blend comprised 28 wt. % diethyl phthalate as the plasticizer and the plasticizer and cellulose acetate were mixed at 80° C. for 6 hours.

### Comparative Example E

Comparative Example E was prepared as follows. Diethyl phthalate was added to cellulose acetate at a temperature of 80° C. and the components were mixed for 4 hours to form a blend comprising 28 wt. % diethyl phthalate and 72 wt. % cellulose acetate. The blend was not fed to a pellet mill and thus remained in flake form. Comparative Example E is similar to Examples 13 and 15, except that it remains in flake form.

### Comparative Example F

Comparative Example F was prepared using the same process as Comparative Example E, except that diethylene phthalate was added to cellulose acetate at room temperature and the components were mixed for 1 minute. Additionally, the cellulose acetate flake had a moisture content from 2 to 5 wt. %.

### Comparative Example G

Comparative Example G was prepared using the same process as Comparative Example E, except that the cellulose acetate flake was a commercially available flake.

### Testing of Examples 13-17 and Comparative Examples E-G

The tensile modulus and flex modulus for each of Examples 13-17 and Comparative Examples E-G were tested as in Examples 8-12 and Comparative Examples A-D. The results are shown in Table 3. Forming a densified pellet improved clumping, but did not adversely affect the tensile modulus or flex modulus of the cellulose acetate/plasticizer blend, pellet, or shaped object prepared therefrom.

The tensile strength (break stress) and flexural strength (stress as 3.5%) for each of Examples 13-17 and Comparative Examples E-G were tested were tested as in Examples 8-12 and Comparative Examples A-D. The results are shown in Table 3. As indicated by the results, forming a densified pellet improved clumping, but did not adversely affect the tensile strength or flexural strength of the cellulose acetate/plasticizer blend, pellet, or shaped object prepared therefrom.

The elongation at break for each of Examples 13-17 and Comparative Examples E-G was tested were tested as in Examples 8-12 and Comparative Examples A-D. The results are shown in Table 3. As indicated by the results, forming a densified pellet improved clumping, but did not adversely affect the elongation at break of the cellulose acetate/plasticizer blend, pellet, or shaped object prepared therefrom.

The strain rate for each of Examples 13-17 and Comparative Examples E-G was tested were tested as in Examples 8-12 and Comparative Examples A-D. The results are shown in Table 3. As indicated by the results, forming a densified pellet improved clumping, but did not adversely affect the strain rate of the cellulose acetate/plasticizer blend, pellet, or shaped object prepared therefrom.

The deflection temperature under load (DTUL) for each of Examples 13-17 and Comparative Examples E-G was tested at 1.8 MPA. As indicated by the results, forming a densified pellet improved clumping, but did not adversely affect the DTUL of the cellulose acetate/plasticizer blend.

The melt viscosity for each of Examples 14-17 and Comparative Examples E-G was tested at 1000 Pa·s and at 400 Pa·s in accordance with ISO 11443 (2014). The results are shown in Table 3. For the inventive examples, forming a densified pellet improved clumping, but did not adversely affect the melt viscosity of the cellulose acetate/plasticizer blend, pellet or shaped object prepared therefrom.

TABLE 3
Testing Results for Examples 13-17 and Comparative Examples E-G

| Example | Comp. E | 13 | 15 | Comp. F | Comp. G | 14 | 16 | 17 |
|---|---|---|---|---|---|---|---|---|
| Tensile Modulus | 2288 | 2411 | 2426 | 2383 | 2117 | 2321 | 2055 | 2138 |
| (MPa) | | | | | | | | |
| Flex Modulus | 2383 | 2441 | 2428 | 2426 | 2109 | 2360 | 2273 | 2320 |
| (MPa) | | | | | | | | |
| Tensile Strength | 44.35 | 46.9 | 47.61 | 48.08 | 37.58 | 46.31 | 43.13 | 39.75 |
| (MPa) | | | | | | | | |
| Flexural | 49.12 | 51.29 | 51.89 | 51.27 | 45.42 | 49.6 | 48.6 | 46.79 |
| Strength at 3.5% | | | | | | | | |
| (MPa) | | | | | | | | |
| Elongation at | 15.18 | 13.89 | 16.32 | 18.22 | 15.58 | 17.34 | 17.63 | 9.69 |
| Break (%) | | | | | | | | |
| Notched Charpy | 12.1 | 10.5 | 11.2 | 11.8 | 12.5 | 12.2 | 12 | 12.3 |
| (kJ/m²) | | | | | | | | |
| DTUL at 1.8 | 56.3 | 62.5 | 60.8 | 63 | 54.3 | 65.2 | 60.2 | 57.7 |
| MPa (° C.) | | | | | | | | |
| Melt Viscosity | 131.8 | 145.4 | 149.1 | 140.7 | 121.2 | 150.2 | 133.5 | — |
| 1000(Pa · s) | | | | | | | | |
| Melt Viscosity | 279.2 | 300.4 | 308.6 | 296.2 | 252.5 | 338.5 | 283.4 | — |
| 400(Pa · s) | | | | | | | | |

### Example 18

Example 18 was prepared using the same process of Example 13, except that the blend comprised 26 wt. % triacetin as the plasticizer.

### Example 19

Example 19 was prepared using the same process of Example 18, except that the cellulose acetate flake was not dried and had a moisture content from 2 to 5 wt. %. Additionally, the blend was prepared at room temperature with 1 minute of mixing.

### Example 20

Example 20 was prepared using the same process of Example 18, except that an antioxidant was added to the blend.

### Example 21

Example 21 was prepared using the same process as Example 18, except the blend was prepared using a pin mixer.

### Example 22

Example 22 was prepared using the same process as Example 18, except that the flake was dried prior to blending. Additionally, after storage, the pellet was dried prior to compounding.

### Example 23

Example 23 was prepared using the same process as Example 18, except that the flake was dried prior to blending. Additionally, the blend was prepared at room temperature and was mixed for ten seconds.

### Example 24

Example 24 was prepared using the same process as Example 18, except the blend further comprised 0.5 wt. % epoxidized soybean oil.

### Comparative Example H

Comparative Example H was prepared as follows. Triacetin was added to cellulose acetate at a temperature of 80° C. and the components were mixed for 4 hours to form a blend comprising 26 wt. % triacetin and 72 wt. % cellulose acetate. The blend was not fed to a pellet mill and thus remained in flake form. Comparative Example E is similar to Example 17, except that it remains in flake form. Clumping was observed in the mixing chamber.

### Testing of Examples 18-24 and Comparative Example H

The tensile modulus and flex modulus for each of Examples 18-24 and Comparative Example H were tested as in Examples 8-12 and Comparative Examples A-D. The results are shown in Table 4. As indicated by the results, forming a densified pellet improved clumping, but did not adversely affect the tensile modulus or flex modulus of the cellulose acetate/plasticizer blend, pellet, or shaped object prepared therefrom.

The tensile strength (break stress) and flexural strength (stress as 3.5%) for each of Examples 18-24 and Comparative Examples H were tested were tested as in Examples 8-12 and Comparative Examples A-D. The results are shown in Table 4. As indicated by the results, forming a densifled pellet improved clumping, but did not adversely affect the tensile strength or flexural strength of the cellulose acetate/plasticizer blend, pellet, or shaped object prepared therefrom.

The elongation at break for each of Examples 18-24 and Comparative Example H was tested as in Example 2 and Comparative Examples A-D. The results are shown in Table 4. As indicated by the results, forming a densified pellet improved clumping, but did not adversely affect the elongation at break of the cellulose acetate/plasticizer blend, pellet, or shaped object prepared therefrom.

The strain rate for each of Examples 18-24 and Comparative Example H was tested were tested as in Examples 8-12 and Comparative Examples A-D. The results are shown in Table 4. As indicated by the results, forming a densified pellet improved clumping, but did not adversely affect the strain rate of the cellulose acetate/plasticizer blend, pellet, or shaped object prepared therefrom.

The deflection temperature under load (DTUL) for each of Examples 18-24 and Comparative Example H was tested at 1.8 MPA. As indicated by the results, forming a densified pellet improved clumping, but did not adversely affect the DTUL of the cellulose acetate/plasticizer blend.

The melt viscosity for each of Examples 18-24 and Comparative Example H was tested as in Examples 13-17 and Comparative Examples E-G. The results are shown in Table 4. As indicated by the results, forming a densified pellet improved clumping, but did not adversely affect the melt viscosity of the cellulose acetate/plasticizer blend, pellet or shaped object prepared therefrom.

TABLE 4
Testing Results for Examples 20-26 and Comparative Example H

| Example | Comp. H | 20 | 21 | 22 | 23 | 24 | 25 | 26 |
|---|---|---|---|---|---|---|---|---|
| Tensile Modulus | 2605 | 2705 | 2435 | 2470 | 2551 | 2618 | 2772 | 2559 |
| (MPa) | | | | | | | | |
| Flex Modulus | 2846 | 2853 | 2717 | 2636 | 2845 | 2997 | 2911 | 2816 |
| (MPa) | | | | | | | | |
| Tensile Strength | 56.23 | 54.91 | 53.49 | 51.33 | 55.21 | 55.53 | 59.17 | 53.51 |
| (MPa) | | | | | | | | |
| Flexural | 60.07 | 60.74 | 58.33 | 57.22 | 60.55 | 62.89 | 63.06 | 58.92 |
| Strength at 3.5% | | | | | | | | |
| (MPa) | | | | | | | | |
| Elongation at | 10.52 | 6.42 | 7.44 | 5.1 | 5.34 | 6.67 | 7.05 | 8.97 |
| Break (%) | | | | | | | | |
| Notched Charpy | 9.8 | 10.6 | 9.7 | 9.1 | 9.7 | 10.2 | 9.4 | 7.9 |
| (kJ/m²) | | | | | | | | |
| DTUL at 1.8 | 61.1 | 60.6 | 62.8 | 59.9 | 60.4 | 62.8 | 63.2 | 60.9 |
| MPa (° C.) | | | | | | | | |
| Melt Viscosity | 167.4 | 187.4 | 197.9 | 172.2 | 216.9 | 207.4 | 193.7 | 192.8 |
| 1000(Pa · s) | | | | | | | | |
| Melt Viscosity | 348 | 384.5 | 391.2 | 369.9 | 386.6 | 359.1 | 368.7 | 363.5 |
| 400(Pa · s) | | | | | | | | |

With each of the inventive examples where the plasticized ester was formed into a densified pellet, handling of the pellets was improved as compared to handling plasticized flake or powder. Additionally, the rate at which the densified pellets could be fed to the compounding and extruding process was greater than the rates for which power or flake could be fed. This rate improvement was at least partially due to reduced clumping of the densified pellets. Because the rates were improved and because clumps did not have to be removed from the process, yield was also improved as compared to the Comparative Examples. Clumping was observed in Comparative Example H. Handling of the densified pellets was simpler.

While the invention has been described in detail, modifications within the spirit and scope of the invention will be readily apparent to those of skill in the art. It should be understood that aspects of the invention and portions of various embodiments and various features recited above and/or in the appended claims may be combined or interchanged either in whole or in part. In the foregoing descriptions of the various embodiments, those embodiments which refer to another embodiment may be appropriately combined with other embodiments as will be appreciated by one of ordinary skill in the art. Furthermore, those of ordinary skill in the art will appreciate that the foregoing description is by way of example only, and is not intended to limit the invention.

We claim:

1. A process for densifying cellulose ester flake, the process comprising:
a) mixing cellulose ester flake with a plasticizer to form a blend, wherein the blend comprises from 5 to 50 wt. % plasticizer; and
b) feeding the blend through a pellet mill to form densified cellulose acetate pellet;
wherein forming the cellulose acetate pellet generates heat;
wherein the cellulose ester pellets exit the pellet mill at a temperature from 40 to 100° C.; and
wherein the pellet is storage stable for at least 24 hours at room temperature and 30 to 35% humidity.

2. The process of claim 1, wherein the feeding of the blend through the pellet mill is gravimetric.

3. The process of claim 1, wherein no heat input is used for the pellet mill.

4. The process of claim 1, wherein step b) further comprises cooling the pellet after it exits the pellet mill.

5. The process of claim 1, wherein the plasticizer is selected from the group consisting of triacetin, trimethyl phosphate, triethyl phosphate, tributyl phosphate, triphenyl phosphate, triethyl citrate, acetyl trimethyl citrate, acetyl triethyl citrate, acetyl tributyl citrate, dibutyl phthalate, diaryl phthalate, diethyl phthalate, dimethyl phthalate, di-2-methoxyethyl phthalate, di-octyl phthalate (and isomers), dibutyl tartrate, ethyl o-benzoylbenzoate, ethyl phthalyl ethyl glycolate, methyl phthalyl ethyl glycolate, n-ethyltoluenesulfonamide, o-cresyl p-toluenesulfonate, aromatic diol, substituted aromatic diols, aromatic ethers, tripropionin, polycaprolactone, glycerin, glycerin esters, diacetin, polyethylene glycol, polyethylene glycol esters, polyethylene glycol diesters, di-2-ethylhexyl polyethylene glycol ester, diethylene glycol, polypropylene glycol, polyglycoldiglycidyl ethers, dimethyl sulfoxide, N-methylpyrollidinone, propylene carbonate, C₁-C₂₀ diacid esters, dimethyl adipate and other dialkyl esters, resorcinol monoacetate, catechol, catechol esters, phenols, epoxidized soy bean oil, castor oil, linseed oil, epoxidized linseed oil, other vegetable oils, other seed oils, difunctional glycidyl ether based on polyethylene glycol, alkylphosphate esters, phospholipids, aromas and combinations thereof.

6. The process of claim 1, wherein the plasticizer is selected from the group consisting of triacetin, triethyl citrate, diacetin, acetyl triethyl citrate, tributyl citrate, acetyl trihexyl citrate, butyryl trihdexyl citrate, trimethyl citrate, and combinations thereof.

7. The process of claim 1, wherein density of the densified pellet is at least 30% greater than the density of the flake.

8. The process of claim 1, wherein the densified cellulose acetate pellet comprises from 10 to 30 wt. % plasticizer.

9. The process of claim 1, wherein the plasticizer is a non-phthalate plasticizer.

10. The process of claim 1, wherein step a) further comprising mixing an additive with the blend.

11. The process of claim 1, wherein the additive is selected from the group consisting of an active particle, an antioxidant, an active compound, a nanoparticle, an abrasive particulate, an absorbent particulate, a softening agent, a flame retardant, a pigment, a dye, a flavorant, an aroma, a controlled release vesicle, a binder, an adhesive, a tackifier, a surface modification agent, a lubricating agent, an emulsifier, a vitamin, a peroxide, a biocide, an antifungal, an antimicrobial, a deodorizer, an antistatic agent, an antifoaming agent, a degradation agent, a conductivity modifying agent, a stabilizing agent, and combinations thereof.

12. The process of claim 11, wherein the blend comprises from 0.1 to 5 wt. % additive.

13. The process of claim 1, wherein step b) further comprises introducing an additive into the pellet mill.

14. The process of claim 1, wherein the blend is not subjected to any drying prior to step b).

15. The process of claim 1, wherein the pellet is not subjected to any drying between steps b) and c).

16. The process of claim 1, wherein the blend comprises from 0.2 to 5 wt. % moisture

17. The process of claim 1, wherein step a) is conducted at a temperature from 25 to 80° C.

18. The process of claim 1, wherein the cellulose ester and the plasticizer are mixed from 1 minute to 4 hours.

19. A process for densifying a cellulose ester pellet, the process comprising:
a) mixing cellulose ester flake having a density from 200 to 320 kg/m³ with a plasticizer to form a blend comprising from 5 to 50 wt. % plasticizer; and
b) directly feeding the blend and at least one additive to a pellet mill to form a densified cellulose ester pellet having a density from 320 to 650 kg/m³, provided that the density of the pellet is at least 30% greater than the density of the flake.

20. A densified cellulose ester pellet, wherein the pellet comprises from 5 to 50 wt. % plasticizer and from 50 to 95 wt. % cellulose ester, and further wherein the pellet has a density from 320 to 650 kg/m³.
